(19) United States
(12) Patent Application Publication
(10) Pub. No.: US 2024/0348404 A1
(43) Pub. Date: Oct. 17, 2024

(54) METHOD AND APPARATUS FOR PHYSICAL UPLINK CONTROL CHANNEL (PUCCH) TRANSMISSION

(71) Applicant: Lenovo (Beijing) Limited, Beijing (CN)

(72) Inventors: Wei Ling, Beijing (CN); Yi Zhang, Beijing (CN); Chenxi Zhu, Beijing (CN); Bingchao Liu, Beijing (CN); Lingling Xiao, Beijing (CN)

(73) Assignee: Lenovo (Beijing) Limited, Beijing (CN)

(21) Appl. No.: 18/580,092

(22) PCT Filed: Aug. 5, 2021
(86) PCT No.: PCT/CN2021/110777

§ 371 Date: Jan. 17, 2024

(51) Int. Cl. H04L 5/00; H04W 72/21

(52) U.S. Cl. CPC H04L 5/0053; H04W 72/21

(57) ABSTRACT

Embodiments of the present application are related to a method and apparatus for physical uplink control channel (PUCCH) transmission. An exemplary method of the present application includes: receiving a plurality of joint or UL common TCI states to be used for PUCCH transmission associated with a plurality of CORESETPoolIndex values, wherein each TCI state of the plurality of TCI states is separately indicated by a PDCCH transmitted in a control source set (CORESET) associated with a CORESETPoolIndex value of the plurality of CORESETPoolIndex values; and for a PUCCH resource associated with a corresponding CORESETPoolIndex value of the plurality of CORESETPoolIndex values, transmitting the PUCCH resource according to a TCI state indicated by a PDCCH transmitted in a CORESET associated with the corresponding CORESETPoolIndex value.

### TECHNICAL FIELD

Embodiments of the present application generally relate to wireless communication technology, especially to a method and an apparatus for physical uplink control channel (PUCCH) transmission.

### BACKGROUND

Regarding enhancements on multiple-input multiple-output (MIMO) for new radio (NR), a work item description (WID) approved in NR R17 includes enhancement on multi-beam operation, mainly targeting frequency range (FR)2 while also applicable to FR1. Wherein, a research topic is to identify and specify features to facilitate more efficient (lower latency and overhead) downlink/uplink (DL/UL) beam management to support higher intra-band and L1/L2-centric inter-cell mobility and/or a larger number of configured transmission configuration indication (TCI) states, including common beam for data and control transmission/reception for DL and UL, especially for intra-band carrier aggregation (CA).

In addition, it has been agreed that downlink control information (DCI) format 1_1 and DCI format 1_2 can be used for DL and UL beam indication, and it has been proposed that DCI format 1_1 and DCI format 1_2 can be used for UL only common beam indication in RAN1 #103e. Moreover, more than one joint or UL common beams indicated by DCI in physical downlink control channel(s) (PDCCH) (s) is also under discussion especially for the scenario of multiple transmit-receive points (TRP) s. In a scenario of multi-DCI (M-DCI) based multiple TRPs, joint or UL common beams of different TRPs are separately indicated to UE because each TRP schedules DL or UL transmission independently considering the non-ideal backhaul between multiple TRPs. For a non-common beam indication mode in the scenario of M-DCI based multiple TRPs, a beam is activated for a physical uplink control channel (PUCCH) resource by a media access control (MAC) control element (CE) associated with a TRP. However, for a common beam indication mode in the scenario of M-DCI based multiple TRPs, there is no MAC CE for activating beam(s) for a PUCCH resource. Thus, how to determine the beam of a PUCCH resource in the scenario of M-DCI based multiple TRPs should be solved.

Given the above, the industry still needs to improve technical solutions for PUCCH transmission, especially for PUCCH transmission in the scenario of multiple TRPs, e.g., beam determination for PUCCH transmission in the scenario of M-DCI based multiple TRPs.

### SUMMARY OF THE APPLICATION

One objective of the embodiments of the present application is to provide a technical solution for PUCCH transmission, e.g., beam determination for PUCCH transmission.

According to some embodiments of the present application, a method may include: receiving a plurality of joint or UL common TCI states to be used for PUCCH transmission associated with a plurality of CORESETPoolIndex values, wherein each TCI state of the plurality of TCI states is separately indicated by a PDCCH transmitted in a control source set (CORESET) associated with a CORESETPoolIndex value of the plurality of CORESETPoolIndex values; and for a PUCCH resource associated with a corresponding CORESETPoolIndex value of the plurality of CORESETPoolIndex values, transmitting the PUCCH resource according to a TCI state indicated by a PDCCH transmitted in a CORESET associated with the corresponding CORESETPoolIndex value.

According to some other embodiments of the present application, a method may include: transmitting a plurality of joint or UL common TCI states to be used for PUCCH transmission associated with a plurality of CORESETPoolIndex values, wherein each TCI state of the plurality of TCI states is separately indicated by a PDCCH transmitted in a CORESET associated with a CORESETPoolIndex value of the plurality of CORESETPoolIndex values; and for a PUCCH resource associated with a corresponding CORESETPoolIndex value of the plurality of CORESETPoolIndex values, receiving the PUCCH resource according to a TCI state indicated by a PDCCH transmitted in a CORESET associated with the corresponding CORESETPoolIndex value.

In some embodiments of the present application, the corresponding CORESETPoolIndex value is configured in configuration information of the PUCCH resource. In some other embodiments of the present application, the corresponding CORESETPoolIndex value is configured in configuration information of a PUCCH resource group at least including the PUCCH resource.

In some embodiments of the present application, the PUCCH resource and the corresponding CORESETPoolIndex value are associated via a MAC CE, and the MC CE indicates an identity of a serving cell for which the MAC CE is applied and an identity of a bandwidth part (BWP) for which the MAC CE is applied. According to some embodiments of the present application, the MAC CE indicates the corresponding CORESETPoolIndex value, and one of: an identity of the PUCCH resource or an identity of another PUCCH resource in a PUCCH resource group at least including the PUCCH resource. For the PUCCH resource group, the MAC CE includes an identity of only one PUCCH resource of the PUCCH resource group. According to some other embodiments of the present application, the MAC CE indicates the corresponding CORESETPoolIndex value, and an identity of a PUCCH resource group at least including the PUCCH resource.

In some embodiments of the present application, the PUCCH resource and the corresponding CORESETPoolIndex value are associated via a predefined association between an identity of a PUCCH resource group at least including the PUCCH resource and the corresponding CORESETPoolIndex value.

Some embodiments of the present application also provide an apparatus, including: at least one non-transitory computer-readable medium having computer executable instructions stored therein, at least one receiving circuitry; at least one transmitting circuitry; and at least one processor coupled to the at least one non-transitory computer-readable medium, the at least one receiving circuitry and the at least one transmitting circuitry. The computer executable instructions are programmed to implement a method according to an embodiment of the present application with the at least one receiving circuitry, the at least one transmitting circuitry and the at least one processor.

Embodiments of the present application provide a technical solution for PUCCH transmission, especially for association between a CORESETPoolIndex value and a PUCCH resource (or determination) for a PUCCH resource in the scenario of M-DCI based multiple TRPs, and thus can facilitate and improve the implementation of 5G NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to an embodiment of the present application.

FIG. 2 is a flow chart illustrating a method for PUCCH transmission according to some embodiments of the present application.

FIG. 3 illustrates an exemplary MAC CE design for indicating the association between CORESETPoolIndex values and PUCCH resources according to some embodiments of the present application.

FIG. 4 illustrates an exemplary MAC CE design for indicating the association between CORESETPoolIndex values and PUCCH resources according to some other embodiments of the present application.

FIG. 5 illustrates a block diagram of an apparatus for PUCCH transmission according to some embodiments of the present application.

### DETAILED DESCRIPTION

The detailed description of the appended drawings is intended as a description of preferred embodiments of the present application, and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE) Release 8 and so on. It is contemplated that along with the developments of network architectures and new service scenarios, all embodiments in the present application are also applicable to similar technical problems. Moreover, the terminologies recited in the present application may change, which should not affect the principle of the present application.

A wireless communication system generally includes one or more base stations (BSs) and one or more UE. Furthermore, a BS may be configured with one TRP (or panel) or more TRPs (or panels). A TRP can act like a small BS. The TRPs can communicate with each other by a backhaul link. Such backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

In a wireless communication system, a single TRP can be used to serve one or more UE under the control of a BS. In different scenarios, a TRP may be referred to as different terms. Persons skilled in the art should understand that as 3GPP and the communication technology develop, the terminologies recited in the specification may change, which should not affect the scope of the present application. It should be understood that the TRP(s) (or panel(s)) configured for the BS may be transparent to a UE.

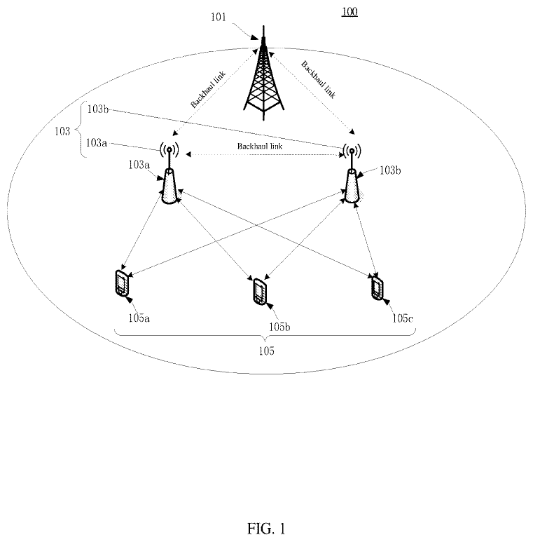

FIG. 1 is a schematic diagram illustrating an exemplary wireless communication system 100 according to some embodiments of the present application.

Referring to FIG. 1, a wireless communication system 100 can include a base station (BS) 101, TRPs 103 (e.g., a TRP 103a and a TRP 103b), and UEs 105 (e.g., a UE 105a, a UE 105b, and a UE 105c). Although only one base station 101, two TRPs 103 and three UEs 105 are shown for simplicity, it should be noted that the wireless communication system 100 may include more or less communication device(s) or apparatus in accordance with some other embodiments of the present application.

In some embodiments of the present application, a BS 101 may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. The UEs 105 (for example, the UE 105a, the UE 105b, and the UE 105c) may include, for example, but is not limited to, a computing device, a wearable device, a mobile device, an IoT device, a vehicle, etc.

The TRPs 103, for example, the TRP 103a and the TRP 103b can communicate with the base station 101 via, for example, a backhaul link. Each of TRPs 103 can serve some or all of UEs 105. As shown in FIG. 1, the TRP 103a can serve some mobile stations (which include the UE 105a, the UE 105b, and the UE 105c) within a serving area or region (e.g., a cell or a cell sector). The TRP 103b can serve some mobile stations (which include the UE 105a, the UE 105b, and the UE 105c) within a serving area or region (e.g., a cell or a cell sector). The TRP 103a and the TRP 103b can communicate with each other via, for example, a backhaul link.

The multi-TRP transmission may refer to at least two TRPs (or panels) to transmit data to a UE. As shown in FIG. 1, for the same UE 105 (e.g., the UE 105a, the UE 105b, or the UE 105c), two TRPs (e.g., the TRP 103a and the TRP 103b) may both transmit data to it, which is an exemplary scenario of the multi-TRP transmission.

According to NR R17, multiple beams, e.g., two beams can be indicated or configured for uplink transmission, e.g., PUCCH transmission without repetition or PUCCH transmission with repetitions. For PUCCH transmission with repetitions, each beam is associated with at least one repetition according to a configured beam mapping pattern. Herein (throughout the specification), the terminology “beam” can be represented (or identified) by various manners, e.g., being represented by “TCI state.” In addition, according to agreements on common beams, a joint or UL common beam can be indicated by a DCI format 1_1 or 1_2, which can be applied for all PUSCH transmissions and all or subset of PUCCH resources. In the scenario of multiple TRPs, considering the non-ideal backhaul between multiple TRPs, the multiple TRPs can schedule DL or UL transmissions independently via DCI in multiple PDCCHs (i.e., M-DCI), and thus the joint or UL common beams of different TRPs for PUCCH transmissions should be separately indicated to the remote side. However, different from a non-common beam indication mode (or non-common beam mode), there is no more MAC CE for a specific PUCCH resource to indicate to which TRP the PUCCH resource is transmitted in a common beam indication mode (or common beam mode).

Thus, when more than one joint or UL common beam is indicated for PUCCH transmission, which may be a PUCCH transmission with repetition or PUCCH transmission without repetition, how to indicate (or determine) the common beam(s) for a specific PUCCH resource should be solved, especially in the scenario of M-DCI based multiple TRPs.

At least for solving the above technical problems, embodiments of the present application provide a technical solution for PUCCH transmission, especially for indication (or determination) of a joint or UL common beam for a PUCCH resource in the scenario of M-DCI based multiple TRPs.

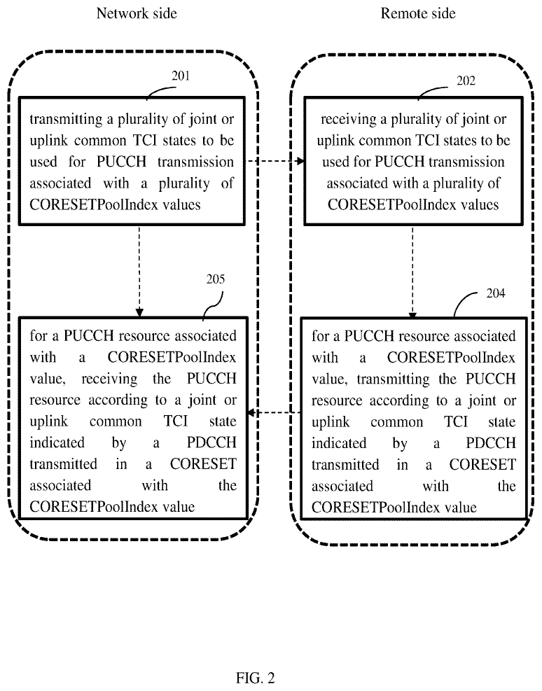

FIG. 2 illustrates a flow chart of a method for PUCCH transmission according to some embodiments of the present application. Although the method is illustrated in a system level by a UE in a remote side (or UE side) and a BS in a network side (or BS side), persons skilled in the art can understand that the method implemented in the remote side and that implemented in the network side can be separately implemented and incorporated by other apparatus with similar functions. In addition, no transmission or reception failure is considered in the illustrated embodiments of the present application.

According to some embodiments of the present application, in the scenario of M-DCI based multiple TRPs, the network side, e.g., the BS 101 as shown in FIG. 1 may indicate a plurality of joint or UL common beams for PUCCH transmissions via DCI in multiple PDCCHs. Herein (throughout the specification), DCI in each PDCCH is also referred to a DCI. For example, as shown in FIG. 2, in step 201, the network side will transmit a plurality of joint or UL TCI states to be used for PUCCH transmissions associated with a plurality of CORESETPoolIndex values to the remote side, e.g., to a UE 105 as shown in FIG. 1. Each TCI state of the plurality of joint or UL common TCI states is separately indicated by a PDCCH, e.g., by DCI in a PDCCH transmitted in a CORESET associated with a CORESETPoolIndex value of the plurality of CORESETPoolIndex values. That is, a joint or UL common beam, identified by a joint or UL common TCI state to be used for a PUCCH transmission to a TRP is indicated by a PDCCH in a CORSET associated with a CORESETPoolIndex value identifying the TRP. In step 202, the plurality of joint or UL common TCI states to be used for PUCCH transmissions associated with the plurality of CORESETPoolIndex values will be received in the remote side, e.g., by the UE 105 as shown in FIG. 1.

A PUCCH transmission can also be referred to as a PUCCH resource. In the case that the number of repetition is defined to be larger than one, the PUCCH transmission can be a PUCCH resource without repetition or a PUCCH resource with repetition. A PUCCH transmission occasion is a repetition of a PUCCH transmission with repetition, or a PUCCH transmission without repetition. While, in the case that the number of repetition is defined to be equal to or larger than one, each PUCCH transmission can be called as a PUCCH resource with repetition, including a PUCCH resource that is only transmitted once. In such a case, a PUCCH transmission occasion is a repetition of a PUCCH transmission.

A PUCCH transmission or PUCCH resource and a CORSETPoolIndex can be configured to be associated with each other by the network side, or can be associated with each other based on a predefined rule.

According to some embodiments of the present application, the association between a CORESETPoolIndex value and a PUCCH resource can be configured by a RRC signaling. For example, a CORESETPoolIndex value associated with a PUCCH resource can be configured by a RRC signaling for configuring the PUCCH resource, that is, a CORESETPoolIndex value associated with a PUCCH resource is configured in the configuration information of the PUCCH resource. In another example, a CORESETPoolIndex value associated with a PUCCH resource can be configured by a RRC signaling for configuring a PUCCH resource group (also referred to as a PUCCH group) at least including the PUCCH resource, that is, a CORESETPoolIndex value associated with a PUCCH resource is configured in the configuration information of a PUCCH resource group at least including the PUCCH resource.

According to some other embodiments of the present application, the association between a CORESETPoolIndex value and a PUCCH resource can be configured by a MAC CE. The MC CE will indicate the identity of a serving cell for which the MAC CE is applied and the identity of a BWP for which the MAC CE is applied. The MAC CE may also indicate the identity of a COREETPoolIndex value and the identity of a PUCCH resource associated with the CORESETPoolIndex value in some other embodiments of the present application. In some other embodiments of the present application, the MAC CE may indicate the identity of a COREETPoolIndex value and the identity of another PUCCH resource in a PUCCH resource group at least including the PUCCH resource associated with the CORESETPoolIndex value. In such a case, for the PUCCH resource group, the MAC CE includes the identity of only one PUCCH resource of the PUCCH resource group. That is, except for the only one indicated PUCCH resource, no other PUCCH resource(s) within the same PUCCH group is indicated in the MAC CE, and this MAC CE will be applied to all the PUCCH resources in the PUCCH group. In some yet other embodiments of the present application, the MAC CE may also indicate the identity of a COREETPoolIndex value and the identity of a PUCCH resource group at least including the PUCCH resource associated with the CORESETPoolIndex value. Similarly, the association between the CORESETPoolIndex value and PUCCH resource group configured in such a MAC CE will be applied to all the PUCCH resources in the PUCCH group.

In the case that the association between a CORESETPoolIndex value and a PUCCH resource is predefined, the CORESETPoolIndex value and the PUCCH resource can be associated with each other via a predefined association between the CORESETPoolIndex value and the identity of a PUCCH resource group at least including the PUCCH resource.

Via the configured or predefined association between CORESETPoolIndex values and PUCCH resources, the joint or UL common beam of a PUCCH resource associated with a CORESETPoolIndex value can be determined as a joint or UL common beam indicated by DCI in a PDCCH transmitted in a CORESET associated with the CORESETPoolIndex value. Thus, for a PUCCH resource associated with a corresponding CORESETPoolIndex value, the PUCCH resource will be transmitted in the remote side and received in the network side according to a joint or uplink common TCI state indicated by a PDCCH transmitted in a CORESET associated with the corresponding CORESETPoolIndex value.

Specifically, as shown in FIG. 2, the remote side, e.g., the UE 105 as shown in FIG. 1 will transmit a PUCCH resource to a TRP identified by a CORESETPoolIndex value according to a joint or UL common TCI state indicated by a PDCCH transmitted in a CORESET associated with the CORESETPoolIndex value in step 204. Accordingly, the network side, e.g., a BS 101 as shown in FIG. 1 will receive the PUCCH resource by a TRP identified by a CORESETPoolIndex value according to a joint or UL common TCI state indicated by a PDCCH transmitted in a CORESET associated with the CORESETPoolIndex value in step 205. Herein (throughout the specification), it is assumed that all the configured (or indicated) joint or UL common beams used for PUCCH transmission are applicable at the time interval of the PUCCH resource transmission. For example, it is assumed that a UL common TCI state, e.g., TCI state 1 indicated by a DCI transmitted in a CORESET associated with CORESETPoolIndex 0 is configured and applicable in the time interval of a PUCCH transmission, and another UL common TCI state, e.g., TCI state 2 indicated by another DCI transmitted in another CORESET associated with CORESETPoolIndex 1 is configured and applicable in the time interval of another PUCCH transmission too. Then for PUCCH resource 0 associated with CORESETPoolIndex 0 via any a solution according to embodiments of the present application and PUCCH resource 1 associated with CORESETPoolIndex 1 via any a solution according to embodiments of the present application, UE will transmit PUCCH resource 0 and PUCCH resource 1 according to TCI state 1 and TCI state 2 respectively.

The association between CORESETPoolIndex values and PUCCH resources according to embodiments of the present application can be implemented in various manners as briefly stated above. More details on the exemplary solutions of the present application will be illustrated in the following text to help understand the technical solutions of the present application. In addition, although the exemplary embodiments may only illustrate two CORESETPoolIndex values for identifying two TRPs respectively, persons skilled in the art should well know the technical solutions based on other CORESETPoolIndex value or TRP numbers under the disclosure and teaching of the present application.

### Solution 1: RRC Signaling

According to some embodiments of the present application, in Solution 1, the association between a CORESETPoolIndex value and a PUCCH resource may be configured per PUCCH resource by a RRC signalling, or may be configured per PUCCH resource group by a RRC signaling, each PUCCH resource group including at least one PUCCH resource. When the association between a CORESETPoolIndex value and a PUCCH resource is configured per PUCCH resource group by a RRC signaling, even if multiple PUCCH groups are configured by the RRC signaling, each PUCCH resource is included in only one of the multiple PUCCH resource groups in the scenario of M-DCI based multiple TRPs. That is, a PUCCH resource cannot be included in more than PUCCH resource group configured by the RRC signaling.

When the association between a CORESETPoolIndex value and a PUCCH resource is configured per PUCCH resource by a RRC signalling, the association between a CORESETPoolIndex value and a PUCCH resource is included in the configuration information of the PUCCH resource or another PUCCH resource of a PUCCH resource group including the PUCCH resource. An exemplary of the RRC signaling for configuring a PUCCH resource in view of two CORESETPoolIndex values for respectively identifying two TRPs is shown as follows:

```
PUCCH-Resource ::= SEQUENCE {
  pucch-ResourceId PUCCH-ResourceId,
  startingPRB PRB-Id,
  intraSlotFrequencyHopping ENUMERATED { enabled } OPTIONAL,
  -- Need R
  secondHopPRB PRB-Id OPTIONAL, -- Need R
  format CHOICE {
    format0 PUCCH-format0,
    format1 PUCCH-format1,
    format2 PUCCH-format2,
    format3 PUCCH-format3,
    format4 PUCCH-format4
    }
  CORESETPoolIndex INTEGER (0..1) OPTIONAL,
}
```

It can be seen a CORESETPoolIndex value 0 or 1 can be configured in the configuration information of a PUCCH resource, so that the configured CORESETPoolIndex value and the PUCCH resource (or other PUCCH resource(s) within the same PUCCH resource group with the PUCCH resource) can be associated with each other. In addition, persons skilled in the art should understand that the segment “CORESETPoolIndex INTEGER (0 . . . 1) OPTIONAL” is only recited for illustration, it may be expressed in other wording, which should not be used to limit the scope of the present application. Hereafter, the same.

When the association between a CORESETPoolIndex value and a PUCCH resource is configured per PUCCH resource group by a RRC signalling, the association between a CORESETPoolIndex value and a PUCCH resource is included in the configuration information of a PUCCH resource group at least including the PUCCH resource to be transmitted. The association between a CORESETPoolIndex value and a PUCCH resource will be applied to all PUCCH resource(s) in the PUCCH resource group. An exemplary of the RRC signaling for configuring the PUCCH resource group in view of two CORESETPoolIndex values for identifying two TRPs respectively is shown as follows:

```
PUCCH-ResourceGroup-r16 ::= SEQUENCE {
  pucch-ResourceGroupId-r16 PUCCH-ResourceGroupId-r16,
  resourcePerGroupList-r16 SEQUENCE (SIZE
  (1..maxNrofPUCCH-ResourcesPerGroup-r16)) OF PUCCH-ResourceId
  CORESETPoolIndex INTEGER (0..1) OPTIONAL,
}
```

It can be seen that a CORESETPoolIndex value 0 or 1 can be configured in the configuration information of a PUCCH resource group, so that the configured CORESETPoolIndex value and the PUCCH resource group can be associated with each other. Accordingly, a PUCCH resource of the PUCCH resource group can be associated with the CORESETPoolIndex value via the association between the CORESETPoolIndex value and the PUCCH resource group. In addition, persons skilled in the art should understand that the segment “CORESETPoolIndex INTEGER (0 . . . 1) OPTIONAL” is only recited for illustration, it may be expressed in other wording, which should not be used to limit the scope of the present application. Hereafter, the same.

### Solution 2: MAC CE

According to some embodiments of the present application, in Solution 2, the association between a CORESETPoolIndex value and a PUCCH resource is indicated by a MAC CE. The MAC CE may indicate the identity of a serving cell for which the MAC CE is applied, and an identity of a BWP for which the MAC CE is applied. The MAC CE may also indicate: the identity of a CORESETPoolIndex value, and the identity of the PUCCH resource to be transmitted or the identity of another PUCCH resource in a PUCCH resource group at least including the PUCCH resource to be transmitted. Whatever, for a specific PUCCH resource group, the MAC CE includes the identity of a CORESETPoolIndex value and the identity of only one PUCCH resource of the PUCCH resource group. In the other words, when a PUCCH resource indicated in the MAC CE is included in a PUCCH resource group configured by a RRC signaling, the association between a CORESETPoolIndex value and a PUCCH resource in the MAC CE is applied for all PUCCH resource(s) in the PUCCH resource group.

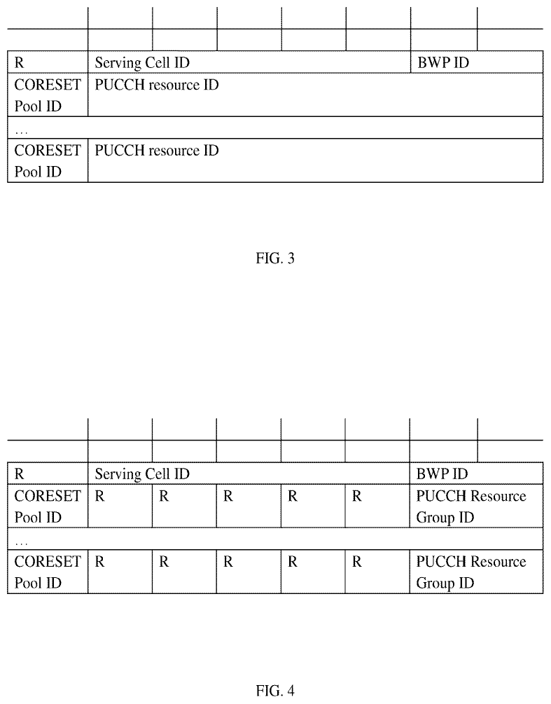

FIG. 3 illustrates an exemplary MAC CE design for indicating the association between CORESETPoolIndex values and PUCCH resources according to some embodiments of the present application.

As shown in FIG. 3, the association between a CORESETPoolIndex value and a PUCCH resource is in the exemplary MAC CE associated with the PUCCH resource to be transmitted, which may indicate the identity of the PUCCH resource to be transmitted or the identity of another PUCCH resource in the same PUCCH resource group as the PUCCH resource to be transmitted in addition to the identity of a CORESETPoolIndex value. The MAC CE may include one or more association between CORESETPoolIndex values and PUCCH resources for different CORESETPoolIndex values and PUCCH resources. Specifically, the MAC CE has a variable size with the following fields:
Serving Cell ID: This field indicates the identity of the serving cell for which the MAC CE applies, and the length of the field is 5 bits;
BWP ID: This field indicates a UL BWP for which the MAC CE applies as the codepoint of the DCI bandwidth part indicator field as specified in TS 38.212, and the length of the BWP ID field is 2 bits;
PUCCH Resource ID: This field contains an identifier of the PUCCH resource ID identified by PUCCH-ResourceId as specified in TS 38.331; the length of the field is 7 bits; if the indicated PUCCH resource is configured as part of a PUCCH resource group as specified in TS 38.331, no other PUCCH resources within the same PUCCH resource group are indicated in the MAC CE; and this MAC CE applies to all the PUCCH resources in the PUCCH resource group;
CORESET Pool ID: This field indicates that a PUCCH resource with the PUCCH resource ID is associated with a CORESETPoolIndex value; if this field is set to 0, it indicates that a PUCCH resource is associated with CORESETPoolIndex 0, and if this filed is set to 1, it indicates that a PUCCH resource is associated with CORESETPoolIndex 1; and the length of the field is 1 bit;
R: Reserved bit, set to 0.

According to some other embodiments of the present application, in Solution 2, the association between CORESETPoolIndex values and PUCCH resources is indicated by a MAC CE for a PUCCH resource group where at least one PUCCH resource is configured in by a RRC signaling, and the association between a CORESETPoolIndex value and a PUCCH resource is applied for all PUCCH resources in the associated PUCCH resource group. The MAC CE may indicate the identity of a serving cell for which the MAC CE is applied, an identity of a BWP for which the MAC CE is applied, a CORESETPoolIndex value and the identity of a PUCCH resource group at least including a PUCCH resource to be transmitted.

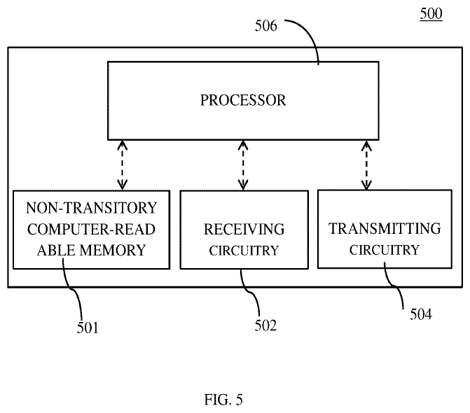

FIG. 4 illustrates an exemplary MAC CE design for indicating the association between CORESETPoolIndex values and PUCCH resources according to some other embodiments of the present application.

As shown in FIG. 4, the association between CORESETPoolIndex values and PUCCH resources is indicated in the exemplary MAC CE, which may indicate the identity of the PUCCH resource group at least including a PUCCH resource to be transmitted in addition to the identity of CORESETPoolIndex value associated with the PUCCH resource to be transmitted. The MAC CE may include one or more association between CORESETPoolIndex value and PUCCH resource for different CORESETPoolIndex values and PUCCH resource groups. Specifically, the MAC CE has a variable size with the following fields:
Serving Cell ID: This field indicates the identity of the serving cell for which the MAC CE applies, and the length of the field is 5 bits;
BWP ID: This field indicates a UL BWP for which the MAC CE applies as the codepoint of the DCI bandwidth part indicator field as specified in TS 38.212, and the length of the BWP ID field is 2 bits;
PUCCH Resource Group ID: This field contains an identifier of the PUCCH resource group ID identified by PUCCH-ResourceGroupId as specified in TS 38.331, and the length of the field is 2 bits, and this MAC CE applies to all the PUCCH resources in a PUCCH group with the PUCCH-ResourceGroupId;
CORESET Pool ID: This field indicates that a PUCCH resource with the PUCCH Resource ID is associated with a CORESETPoolIndex value; if this field is set to 0, it indicates that a PUCCH resource is associated with CORESETPoolIndex 0, and if this filed is set to 1, it indicates that a PUCCH resource is associated with CORESETPoolIndex 1; and the length of the field is 1 bit;
R: Reserved bit, set to 0.

### Solution 3: Predefined Association

According to some embodiments of the present application, in Solution 3, the association between a CORESETPoolIndex value and a PUCCH resource is predefined via a predefined association between an identity of a PUCCH resource group at least including the PUCCH resource and the CORESETPoolIndex value.

For example, when there are only two TRPs, e.g., respectively identified by CORESETPoolIndex 0 and CORESETPoolIndex 1 and only two PUCCH resource groups are configured, a predefined association between CORESETPoolIndex values and PUCCH resources may be: all PUCCH resources in the PUCCH resource group with a lower index of the two PUCCH groups are associated with CORESETPoolIndex 0 and all PUCCH resources in the PUCCH resource group with a higher index of the two PUCCH groups are associated with CORESETPoolIndex 1.

In addition, embodiments of the present application also propose an apparatus for PUCCH transmission. For example, FIG. 5 illustrates a block diagram of an apparatus 500 for PUCCH transmission according to some embodiments of the present application.

As shown in FIG. 5, the apparatus 500 may include at least one non-transitory computer-readable medium 501, at least one receiving circuitry 502, at least one transmitting circuitry 504, and at least one processor 506 coupled to the non-transitory computer-readable medium 501, the receiving circuitry 502 and the transmitting circuitry 504. The apparatus 500 may be a network side apparatus (e.g., a BS) configured to perform a method illustrated in FIG. 2 and the like, or a remote unit (e.g., a UE) configured to perform a method illustrated in FIG. 5 or the like.

Although in this figure, elements such as the at least one processor 506, transmitting circuitry 504, and receiving circuitry 502 are described in the singular, the plural is contemplated unless a limitation to the singular is explicitly stated. In some embodiments of the present application, the receiving circuitry 502 and the transmitting circuitry 504 can be combined into a single device, such as a transceiver. In certain embodiments of the present application, the apparatus 500 may further include an input device, a memory, and/or other components.

For example, in some embodiments of the present application, the non-transitory computer-readable medium 501 may have stored thereon computer-executable instructions to cause a processor to implement the method with respect to the UE as described above. For example, the computer-executable instructions, when executed, cause the processor 506 interacting with receiving circuitry 502 and transmitting circuitry 504, so as to perform the steps with respect to the UE depicted in FIG. 2.

In some embodiments of the present application, the non-transitory computer-readable medium 501 may have stored thereon computer-executable instructions to cause a processor to implement the method with respect to the BS as described above. For example, the computer-executable instructions, when executed, cause the processor 506 interacting with receiving circuitry 502 and transmitting circuitry 504, so as to perform the steps with respect to the BS depicted in FIG. 2.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A method, comprising:
receiving a plurality of joint or uplink common transmission configuration indication (TCI) states associated with a plurality of CORESETPoolIndex values, wherein each TCI state of the plurality of joint or uplink common TCI states is separately indicated by a physical downlink control channel (PDCCH) transmitted in a control resource set (CORESET) associated with a CORESETPoolIndex value of the plurality of CORESETPoolIndex values; and
for a physical uplink control channel (PUCCH) resource associated with a corresponding CORESETPoolIndex value of the plurality of CORESETPoolIndex values, transmitting the PUCCH resource according to a joint or uplink common TCI state indicated by the PDCCH transmitted in the CORESET associated with the corresponding CORESETPoolIndex value.

2. The method of claim 1, wherein the corresponding CORESETPoolIndex value is associated with the PUCCH resource by a radio resource control (RRC) parameter configured in configuration information of the PUCCH resource, or is associated with the PUCCH resource by the RRC parameter configured in configuration information of a PUCCH resource group at least comprising the PUCCH resource.

3. The method of claim 1, wherein the PUCCH resource and the corresponding CORESETPoolIndex value are associated via a medium access control (MAC) control element (CE), and the MAC CE indicates an identity of a serving cell for which the MAC CE is applied and an identity of a bandwidth part (BWP) for which the MAC CE is applied.

4-5. (canceled)

6. The method of claim 3, wherein the MAC CE indicates the corresponding CORESETPoolIndex value, and an identity of a PUCCH resource group at least comprising the PUCCH resource.

7. The method of claim 1, wherein the PUCCH resource and the corresponding CORESETPoolIndex value are associated via a predefined association between an identity of a PUCCH resource group at least comprising the PUCCH resource and the corresponding CORESETPoolIndex value.

8. A base station (BS) for wireless communication, comprising:
at least one memory; and
at least one processor coupled with the at least one memory and configured to cause the BS to:
transmit a plurality of joint or uplink common transmission configuration indication (joint or uplink common TCI) states associated with a plurality of CORESETPoolIndex values, wherein each TCI state of the plurality of joint or uplink common TCI states is separately indicated by a physical downlink control channel (PDCCH) transmitted in a control resource set (CORESET) associated with a CORESETPoolIndex value of the plurality of CORESETPoolIndex values; and
for a physical uplink control channel (PUCCH) resource associated with a corresponding CORESETPoolIndex value of the plurality of CORESETPoolIndex values, receiving the PUCCH resource according to a joint or uplink common TCI state indicated by the PDCCH transmitted
in the CORESET associated with the corresponding CORESETPoolIndex value.

9. The BS of claim 8, wherein the corresponding CORESETPoolIndex value is associated with the PUCCH resource by a radio resource control (RRC) parameter configured in configuration information of the PUCCH resource, or is associated with the PUCCH resource by the RRC parameter configured in configuration information of a PUCCH resource group at least comprising the PUCCH resource.

10. The BS of claim 8, wherein the PUCCH resource and the corresponding CORESETPoolIndex value are associated via a medium access control (MAC) control element (CE), and the MAC CE indicates an identity of a serving cell for which the MAC CE is applied and an identity of a bandwidth part (BWP) for which the MAC CE is applied.

11. The BS of claim 10, wherein the MAC CE indicates the corresponding CORESETPoolIndex value, and one of: an identity of the PUCCH resource or an identity of another PUCCH resource in a PUCCH resource group at least comprising the PUCCH resource.

12. The BS of claim 11, wherein for the PUCCH resource group, the MAC CE comprises an identity of only one PUCCH resource of the PUCCH resource group.

13. The BS of claim 10, wherein the MAC CE indicates the corresponding CORESETPoolIndex value, and an identity of a PUCCH resource group at least comprising the PUCCH resource.

14. The BS of claim 8, wherein the PUCCH resource and the corresponding CORESETPoolIndex value are associated via a predefined association between an identity of a PUCCH resource group at least comprising the PUCCH resource and the corresponding CORESETPoolIndex value.

15. (canceled)

16. A user equipment (UE) for wireless communication, comprising:
at least one memory; and
at least one processor coupled with the at least one memory and configured to cause the UE to:
receive joint or uplink common transmission configuration indication (TCI) states associated with CORESETPoolIndex values, wherein each TCI state of the joint or uplink common TCI states is separately indicated by a physical downlink control channel (PDCCH) transmitted in a control resource set (CORESET) associated with a CORESETPoolIndex value of the CORESETPoolIndex values; and
for a physical uplink control channel (PUCCH) resource associated with a corresponding CORESETPoolIndex value of the CORESETPoolIndex values, transmit the PUCCH resource according to a joint or uplink common TCI state indicated by the PDCCH transmitted in the CORESET associated with the corresponding CORESETPoolIndex value.

17. The UE of claim 16, wherein the corresponding CORESETPoolIndex value is associated with the PUCCH resource by a radio resource control (RRC) parameter configured in configuration information of the PUCCH resource, or is associated with the PUCCH resource by the RRC parameter configured in configuration information of a PUCCH resource group at least comprising the PUCCH resource.

18. The UE of claim 16, wherein the PUCCH resource and the corresponding CORESETPoolIndex value are associated via a medium access control (MAC) control element (CE), and the MAC CE indicates an identity of a serving cell for which the MAC CE is applied and an identity of a bandwidth part (BWP) for which the MAC CE is applied.

19. The UE of claim 18, wherein the MAC CE indicates the corresponding CORESETPoolIndex value, and one of an identity of the PUCCH resource, or an identity of another PUCCH resource in a PUCCH resource group at least comprising the PUCCH resource.

20. The UE of claim 19, wherein, for the PUCCH resource group, the MAC CE comprises an identity of only one PUCCH resource of the PUCCH resource group.

21. The UE of claim 18, wherein the MAC CE indicates the corresponding CORESETPoolIndex value, and an identity of a PUCCH resource group at least comprising the PUCCH resource.

22. The UE of claim 16, wherein the PUCCH resource and the corresponding CORESETPoolIndex value are associated via a predefined association between an identity of a PUCCH resource group at least comprising the PUCCH resource and the corresponding CORESETPoolIndex value.

23. A processor for wireless communication, comprising:
at least one controller coupled with at least one memory and configured to cause the processor to:
receive joint or uplink common transmission configuration indication (TCI) states associated with CORESETPoolIndex values, wherein each TCI state of the joint or uplink common TCI states is separately indicated by a physical downlink control channel (PDCCH) transmitted in a control resource set (CORESET) associated with a CORESETPoolIndex value of the CORESETPoolIndex values; and
for a physical uplink control channel (PUCCH) resource associated with a corresponding CORESETPoolIndex value of the CORESETPoolIndex values, transmit the PUCCH resource according to a joint or uplink common TCI state indicated by the PDCCH transmitted in the CORESET associated with the corresponding CORESETPoolIndex value.
